(19) United States
(12) Patent Application Publication
(10) Pub. No.: US 2006/0069734 A1
(43) Pub. Date: Mar. 30, 2006

(54) Method and system for organizing and displaying message threads

(76) Inventors: Michael Gersh, Delray Beach, FL (US); Peter Pezaris, Delray Beach, FL (US)

Correspondence Address: PEPPER HAMILTON LLP, ONE MELLON CENTER, 50TH FLOOR, 500 GRANT STREET, PITTSBURGH, PA, 15219, US

(21) Appl. No.: 10/931,756

(22) Filed: Sep. 1, 2004

(51) Int. Cl. G06F 15/16

(52) U.S. Cl. 709/207

(57) ABSTRACT

A method and system for organizing and displaying a message thread list is disclosed. A current counter value and a set of message threads that a user has permission to access are determined. For each message thread in the set, the method determines an elapsed counter value between the current counter value and the first updated message counter value. The first updated message counter value equals the counter value when the first message is added to the message thread after the user last accessed the message thread if the user has accessed the message thread. Otherwise, the first updated message counter value equals the counter value when the message thread was created. The message threads are then ordered based on their elapsed counter value and displayed to the user. A message thread may include emails and/or message board messages.

### TECHNICAL FIELD

The embodiments described herein relate generally to the field of electronic communication. In particular, the embodiments relate to the display and organization of electronic communications in the form of message threads.

### BACKGROUND

People have sought to devise improved methods of communicating with others for many years. The moveable type printing press, the telephone and the television each represent steps towards improving inter-personal communications. The advent of the Internet is the latest means for improving communication. The Internet provides computer users with the opportunity to instantly communicate with numerous people over great distances. The effectiveness of the Internet as a communication tool is evidenced by the increase of Internet users year over year.

Methods of communication on the Internet come in many forms. Email, chat rooms and message boards are currently among the most popular methods. Email permits directed communications to be sent from one user to one or more recipients in a manner similar to regular mail. A chat room is a virtual room permitting real-time conversations to take place between all participants simultaneously. Some chat rooms permit senders to direct messages to less than all participants as well. Message boards permit individuals to post information for others to view. Information posted to a message board is often available to anyone reading the board. However, some message boards limit access to individuals who are designated as recipients by a sender.

Message boards and emails are often organized as message threads. For example, if a user posts a message or sends an email pertaining to a particular topic, the readers or recipients may respond to the message or email. The grouping of all messages associated with an original message or email is called a message thread or a conversation.

Current message boards, and email systems in which the emails are grouped as message threads, typically display message threads in one of three ways. First, the message threads can be displayed based on the creation time of the message thread. Message threads that are created more recently are placed on the top of the ordered list, while older message threads are supplanted by newer message threads. “Creation time” message thread lists do not examine whether replies have been sent to a message thread.

A problem with creation time message thread lists is that active message threads are disfavored as compared to new message threads. In other words, a message thread that generates significant interest among users can be pushed down the creation time message thread list until it is difficult to find. Once the message thread is not directly viewable upon loading the message thread list, users might not post additional messages to the message thread or read messages of interest simply because they are not aware that the message thread exists.

A second typical method of organizing and displaying message threads is based on which message thread contains the most recent message. A message thread that received a more recent message is displayed above a message thread with a less recent message. Accordingly, highly active message threads are typically displayed at the top of the list. In such systems, new message threads are also typically displayed at the top of the list when they are created.

A problem with such “reply time” message thread lists is that new message threads are disfavored. Active message threads may update quickly. If multiple message threads are active simultaneously and a new message thread is submitted, the new message thread may be obscured by new replies to the active message threads before posters even see the new message thread. Accordingly, a discussion that might be of interest to the users of reply time message thread lists may not happen because the new message thread is displaced before users recognize its existence.

Another problem with both creation time and reply time message thread lists occurs when a user engages in a discussion in a particular message thread while other message threads are also active on the message board. If that message thread is the only one of interest to the user but the message thread is lightly discussed, the user would likely prefer to have the message thread of interest appear above the other message threads. However, infrequent updates to the message thread, or simply its age, may cause the message thread to be obscured over time. In particular, if the user logs off for a time, the user may be unable to locate the message thread after logging back on because other message threads might have been updated more recently.

Still other message thread lists are organized such that message threads to which a user has posted are listed first. In contrast to the creation time and reply time message thread lists, message threads to which a user has posted would be listed at or near the top of the message thread list even if the user logs back in after an extended time. However, if a user actively communicates in many message threads, the user may be unable to locate new message threads on topics of interest in such systems because the new message threads are obscured. Moreover, message threads in which the user has lost interest would unnecessarily be displayed near the top of the message thread list due to the user's prior interest.

What is needed is an enhanced method and system for organizing and displaying message threads in an ordered message thread list.

A further need exists for a method and system of prioritizing both message threads in which the reader has shown interest and new message threads simultaneously in a message thread list.

The present embodiments are directed to solving one or more of the above-listed problems.

### SUMMARY

Before the present methods and systems are described, it is to be understood that this invention is not limited to the particular methodologies and systems described, as these may vary. It is also to be understood that the terminology used in the description is for the purpose of describing the particular versions or embodiments only, and is not intended to limit the scope of the invention which will be limited only by the appended claims.

It must also be noted that as used herein and in the appended claims, the singular forms “a,” “an,” and “the” include plural references unless the context clearly dictates otherwise. Thus, for example, reference to a “message thread” is a reference to one or more message threads and equivalents thereof known to those skilled in the art, and so forth. Unless defined otherwise, all technical and scientific terms used herein have the same meanings as commonly understood by one of ordinary skill in the art. Although any methods and systems similar or equivalent to those described herein can be used in the practice or testing of embodiments of the invention, the preferred methods and devices are now described. All publications mentioned herein are incorporated by reference. Nothing herein is to be construed as an admission that the invention is not entitled to antedate such disclosure by virtue of prior invention.

In an embodiment, a method of organizing and displaying an ordered message thread list includes determining a current counter value, determining one or more message threads that are accessible by a user, determining, for each message thread, a first unread message counter value, computing, for each message thread, an elapsed counter value, ordering the one or more message threads into a message thread list based on the elapsed counter value for each message thread, and displaying the message thread list. If the user has not accessed the message thread, the first unread message counter value equals a counter value when the message thread is created. If the user has accessed the message thread, the first unread message counter value equals a counter value when a message is first added to the message thread after the user last accessed the message thread. The elapsed counter value equals the first unread message counter value subtracted from the current counter value. Determining one or more message threads that are accessible by a user may include determining, for each message thread, whether the user has permission to access the message thread. The message thread list may include a message thread list ordered from a message thread having a smallest elapsed counter value to a message thread having a largest elapsed counter value. The message thread having the smallest elapsed counter value may be displayed at the top of the message thread list. A message thread may include one or more of an email message and a message board message. Each of the current counter value, the first unread message counter value and the elapsed counter value may include a time value.

In an embodiment, a system for organizing and displaying an ordered message thread list includes a processor, a computer-readable storage medium operably connected to the processor, a communications network operably connected to the processor, and at least one computer system operably connected to the communications network. The computer-readable storage medium contains one or more programming instructions for performing a method of organizing and displaying an ordered message thread list including receiving, via the communications network, a request from a computer system for a user's message threads, determining, by the processor, a current counter value, determining, by the processor, one or more message threads that are accessible by a user, determining, by the processor for each message thread, a first unread message counter value, computing, by the processor for each message thread, an elapsed counter value, ordering the one or more message threads into a message thread list based on the elapsed counter value for each message thread, and transmitting, via the communications network, the message thread list to the computer system. If the user has not accessed the message thread, the first unread message counter value equals a counter value when the message thread is created. If the user has accessed the message thread, the first unread message counter value equals a counter value when a message is first added to the message thread after the user last accessed the message thread. The elapsed counter value is equal to the first unread message counter value subtracted from the current counter value. Determining one or more message threads that are accessible by a user may include determining, for each message thread, whether the user has permission to access the message thread. The message thread list may include a message thread list ordered from a message thread having a smallest elapsed counter value to a message thread having a largest elapsed counter value. The message thread having the smallest elapsed counter value may be displayed at the top of the message thread list. A message thread may include one or more of an email message and a message board message. Each of the current counter value, the first unread message counter value and the elapsed counter value may include a time value.

In an embodiment, a method of organizing and displaying an ordered message thread list includes determining a current counter value, determining one or more message threads that are accessible by a user, determining, for each message thread, a first unread message counter value, computing, for each message thread, an elapsed counter value, placing, for each message thread, the message thread into an ordered message thread list at a position based on the elapsed counter value for the message thread, and displaying the ordered message thread list. If the user has not accessed the message thread, the first unread message counter value equals a counter value when the message thread is created. If the user has accessed the message thread, the first unread message counter value equals a counter value when a message is first added to the message thread after the user last accessed the message thread. The elapsed counter value is equal to the first unread message counter value subtracted from the current counter value. Determining one or more message threads that are accessible by a user may include determining, for each message thread, whether the user has permission to access the message thread. The ordered message thread list may include a message thread list ordered from a message thread having a smallest elapsed counter value to a message thread having a largest elapsed counter value. The message thread having the smallest elapsed counter value may be displayed at the top of the ordered message thread list. A message thread may include one or more of an email message and a message board message. Each of the current counter value, the first unread message counter value and the elapsed counter value may include a time value.

In an embodiment, a method of presenting a message thread list to a user includes displaying a plurality of message threads in an order corresponding to the time that is the lesser of (1) the time that has elapsed since a message was first added to a message thread after a user last accessed any message in the message thread, and (2) the time that has elapsed since the message thread was created.

### BRIEF DESCRIPTION OF THE DRAWINGS

The accompanying drawings, which are incorporated in and form a part of the specification, illustrate various embodiments and, together with the description, serve to explain the principles of the various embodiments.

FIG. 1 depicts an exemplary flowchart for a method of organizing and displaying an ordered message thread list according to an embodiment.

FIGS. 2A-E depict states of an exemplary ordered message thread list according to an embodiment at ordered time intervals.

FIG. 3 depicts an exemplary computer system for organizing and displaying an ordered message thread list according to an embodiment.

### DETAILED DESCRIPTION

The embodiments described herein relate to enhanced methods and systems for organizing and displaying electronic communications in an ordered message thread list.

The present disclosure describes methods and systems for implementing the organization and display of message threads based on the first unread message in each message thread. In other words, previously viewed message threads having a first-in-time unread reply that is more recent than the first-in-time unread replies for all other message threads may be displayed at the top of the message thread list. In the case of unread message threads, the initial message in the message thread may be the first unread message.

In an embodiment, an elapsed time between the current time and a time at which the first unread message in a message thread occurred is determined for each message thread that the user is permitted to view. For new message threads that the user has not viewed, the elapsed time may be set to the difference between the current time and the time that the initial message is posted in the message thread. The message threads may then be displayed such that the first message thread in the message thread list has the smallest elapsed time value and each successive message thread has the next smallest elapsed time value.

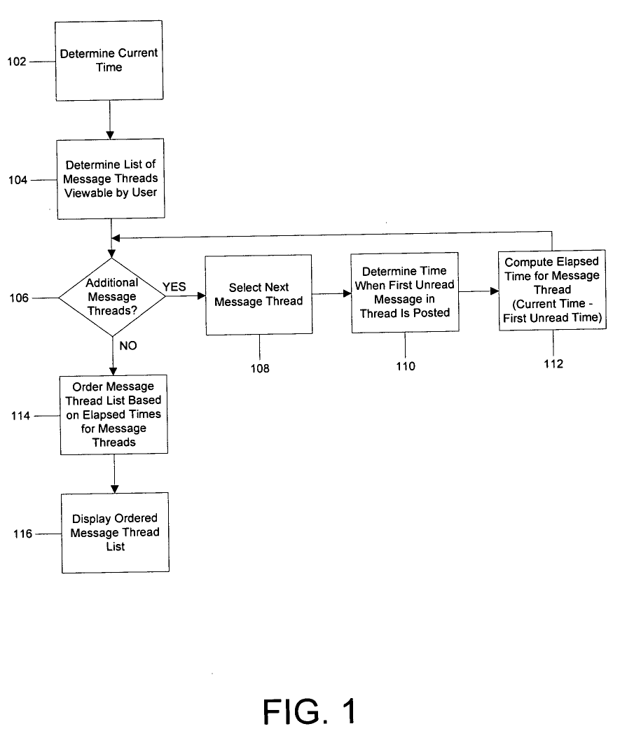

FIG. 1 depicts an exemplary flowchart for a method of organizing and displaying an ordered list of message threads according to an embodiment. Initially, a current time value may be determined 102. The current time value may be represented in an “hours, minutes and seconds” notation, as a computer cycle count or any other system of measuring consecutive distinct states. For example, in an embodiment, a system represents time in a notation understandable by users, such as clock time. In an alternate embodiment, a system uses a counter that is incremented when a message is posted to any message thread, where the counter's value represents the current “time.” In such an embodiment, a state having a higher counter value represents a later time than a state having a lower counter value.

A list of message threads that a user is permitted to view may also be determined 104. In an embodiment, a user may only be allowed to view a subset of all message threads posted on a message board. For example, where a message board comprises an email system, the user may only view email messages directed to the user or sent by the user. Similarly, a message board system in which the creator of a message thread designates one or more users, groups and/or categories of users who may view the message thread may limit the message threads displayed to the user to only those message threads that the user is permitted to view. Conversely, in an unregulated message board system, the user may view all messages posted to all message threads, and a message thread list may contain all message threads posted to the message board.

A determination of whether any message threads have not been processed may be made 106. If at least one message thread has not been processed, a next message thread may be selected 108 for processing. The determination of which message thread is “next” may be implemented by any method or system known by those of ordinary skill in the art. In an embodiment, the list of viewable message threads is limited to message threads that have been updated within a pre-defined time period. In an embodiment, the list of viewable message threads is limited to message threads to which the user has been granted access or which the user has created.

Processing a message thread requires a determination of the time when the first unread message in a message thread was posted 110. The first unread message may be either (1) the original message in a message thread if the user has not viewed any messages in the message thread or (2) the message after the most recently added message that the user has viewed in the message thread if the user has viewed at least one message.

The elapsed time between the first unread message time and the current time may then be computed 112. The elapsed time represents the amount of time between the first update to a viewed message thread after being viewed, or the creation time of an unread message thread, and the current time. In other words, viewed message threads that were first updated more recently have smaller elapsed times than those that were first updated less recently. The elapsed time may be computed for each message thread by iterating over the message threads and performing the operations of 108, 110 and 112.

In an embodiment, once the elapsed time has been computed for all of the message threads, the message threads are ordered 114 based on the elapsed time. In an alternate embodiment, each message thread is ordered 114 in a message thread list prior to computing the elapsed time of the next message thread. Upon completion of the ordering process 114, the ordered list of message threads is displayed 116 to the user. In an embodiment, the message thread having the smallest elapsed time may be displayed at the top of the ordered list.

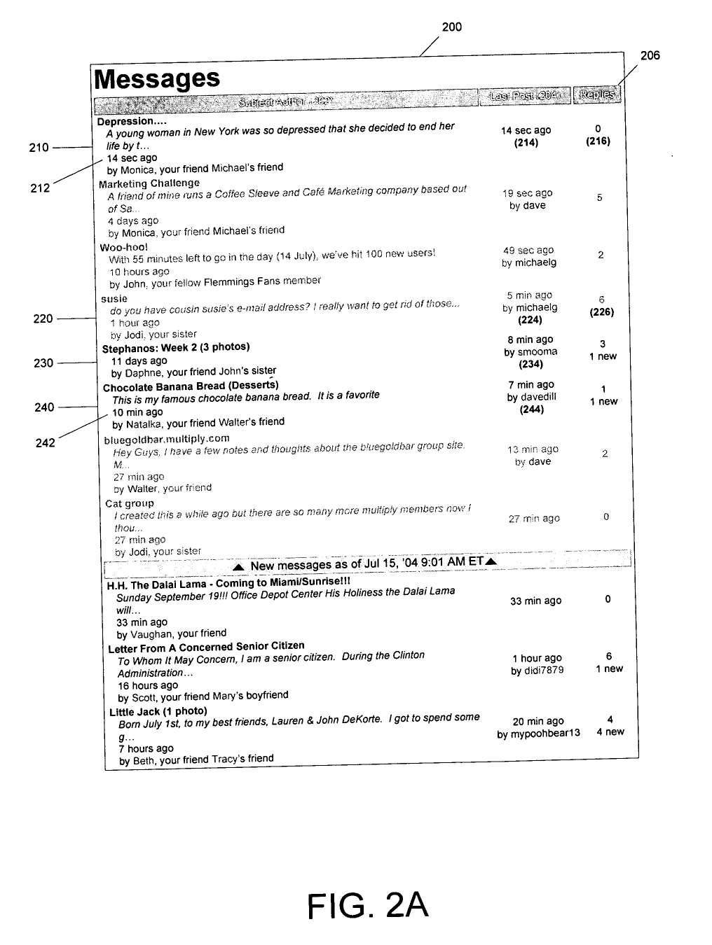

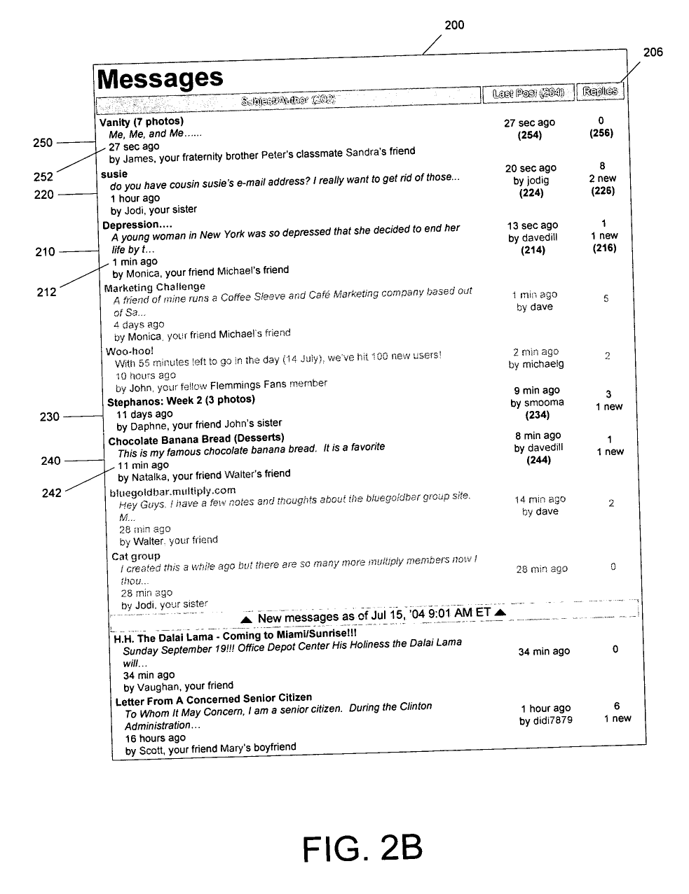

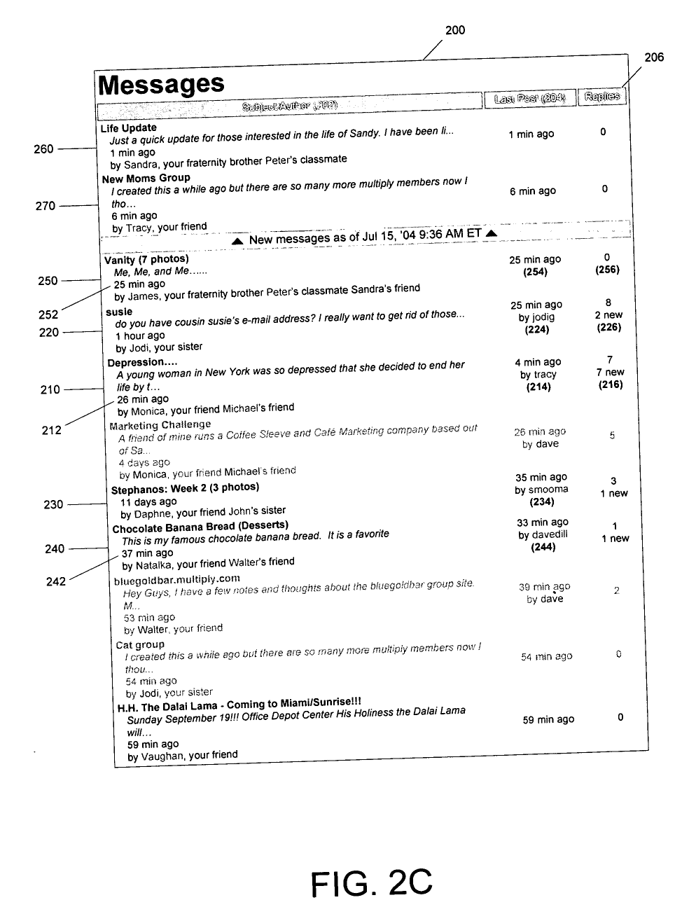

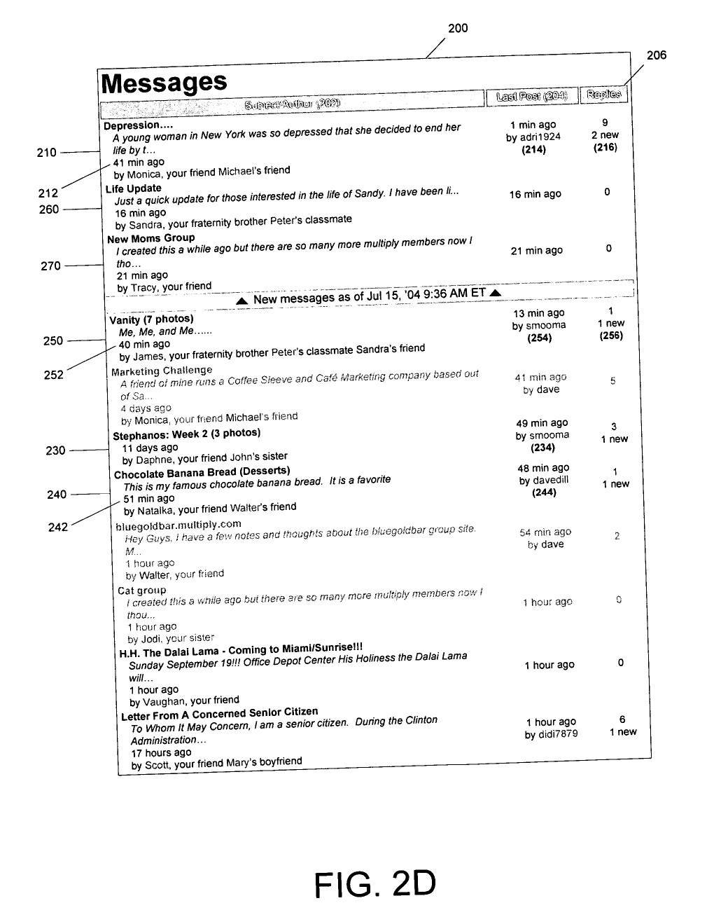

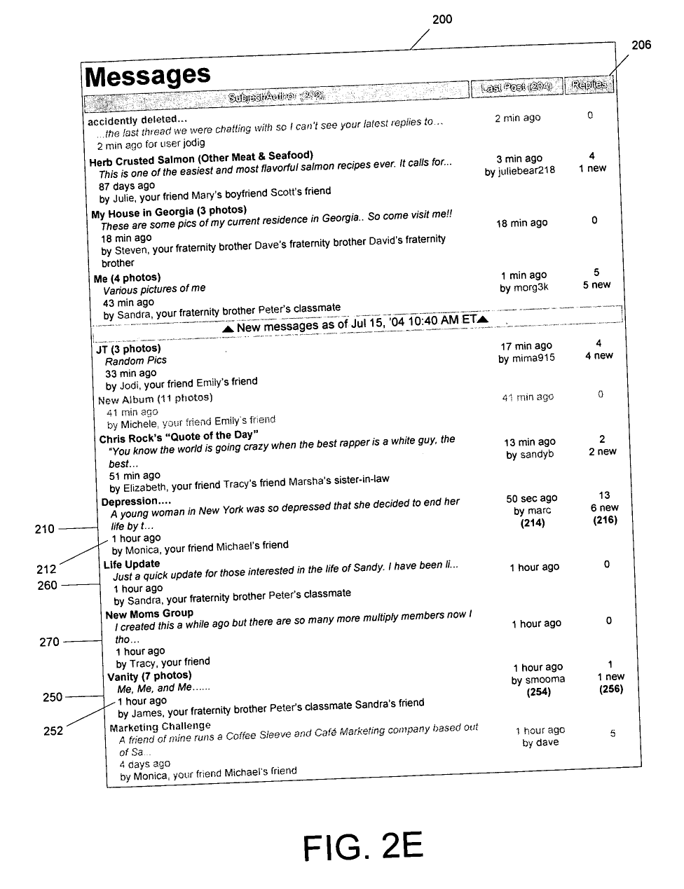

An example message board implementing the above-described method is depicted in FIGS. 2A through 2E. In FIGS. 2A through 2E, message threads in dark text include at least one message that the user has not read. In contrast, the user has read all messages in message threads with lighter text.

FIG. 2A depicts an exemplary organization of a message thread list at a first time interval according to an embodiment. In FIG. 2A, the message thread list 200 includes a subject/author field 202, a last post field 204 and a number of replies field 206 for each message thread. The subject/author field 202 may include a subject for the message thread, a brief excerpt from a message within the message thread and/or a creator of the message thread. In an embodiment, each message thread further includes an elapsed time (e.g., 212) from the time of its creation in its subject/author field 202. The last post field 204 may include the elapsed time from the last message posted to the message thread. If a message thread has one or more replies, the last post field 204 may further display an identifier representing the last user to post a message to the message thread. The number of replies field 206 may display the number of replies to a message thread. When a message thread is first created, the number of replies may be set to zero. In an embodiment, the number of replies field 206 may also display the number of replies in the message thread that are unread. In an embodiment, the unread message count does not include the initial message.

At the first time interval shown in FIG. 2A, message thread 210 may represent a new message thread in which the first message was posted 14 seconds prior (see 214) to loading the message thread list 200. Each of the other message threads in the message thread list 200, such as 220, 230 and 240, has had its first unread message posted less recently than the first unread message in message thread 210 (see 224, 234 and 244). As of the first time interval, no reply messages had been posted to message thread 210 (see 216). Six reply messages had been posted to message thread 220 (see 226).

It is also noted that message thread 230 is listed above message thread 240 despite message thread 240 having a more recent message posted to it (7 minutes 244 vs. 8 minutes 234 prior to loading the message thread list 200). Message threads 230 and 240 are ordered this way because the user has not read any messages in message thread 240, and the original message was posted 10 minutes prior (see 242) to loading the message thread list 200. In contrast, the only message that the user has not read in message thread 230 is the most recently posted message (posted 8 minutes prior 234). Thus, message thread 230 has been more recently updated than message thread 240 (8 minutes prior vs. 10 minutes prior).

In FIG. 2B, message thread 210 has been ordered below two other message threads 220 and 250. Message thread 250 is a new message thread having a creation time 252 after the creation time 212 of message thread 210. Since message thread 210 has not been viewed 216, the fact that a more recent reply has been posted to message thread 210 than to message thread 250 (13 seconds 214 vs. 27 seconds 254) is not considered when ordering the message threads. Similarly, message thread 220 has been viewed more recently than message thread 210. In this case, the exact time at which message thread 220 was viewed may be indeterminable from the information displayed in the message thread list 200 because two replies have been posted 226 to message thread 220 since the last time a message was read. However, the ordering of the message threads denotes that the first unread reply to message thread 220 was posted more recently than the time at which message thread 210 was created.

In FIG. 2C, two new message threads, 260 and 270, have been created. The user has not viewed any of message threads 210, 220 and 250 in the time between the loading of the message thread list represented in FIG. 2B and the loading of the message thread list represented in FIG. 2C. It is noted that the order of message threads 210, 220 and 250 has not changed despite six additional replies 216 being posted to message thread 210.

FIG. 2D depicts the message thread list 200 after the original message and the first seven replies to the original message of message thread 210 were read. Here, the most recent first unread message for a message thread is in message thread 210. In this case, the exact time at which message thread 210 was viewed may be indeterminable from the information displayed in the message thread list 200 because two replies have been posted 216 to message thread 210 since the last time a message was read. However, the ordering of the message threads denotes that the first unread reply to message thread 210 was posted more recently than the times at which message threads 260 and 270 were created.

FIG. 2E depicts a later time interval in which each of message threads 210, 250, 260 and 270 have not been read since the time interval depicted in FIG. 2D. Six new message threads and one more recently updated message thread have been ordered above each of message threads 210, 250, 260 and 270 in the message thread list 200. Note that this has occurred despite additional replies 216 being posted to message thread 210.

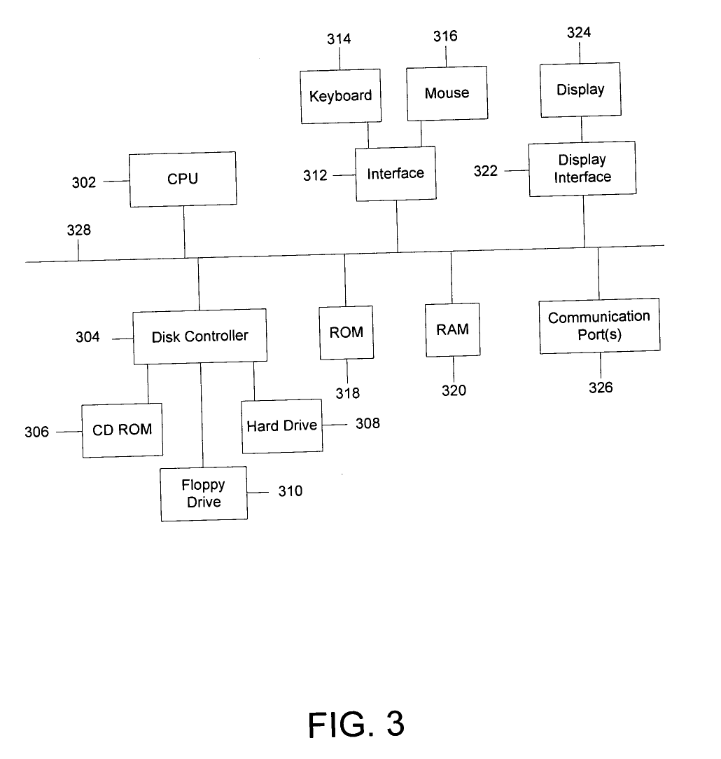

FIG. 3 is a block diagram of exemplary internal hardware that may be used to contain or implement the program instructions of a system embodiment of the present invention. Referring to FIG. 3, a bus 328 serves as the main information highway interconnecting the other illustrated components of the hardware. CPU 302 is the central processing unit of the system, performing calculations and logic operations required to execute a program. Read only memory (ROM) 318 and random access memory (RAM) 320 constitute exemplary memory devices.

A disk controller 304 interfaces with one or more optional disk drives to the system bus 328. These disk drives may be external or internal floppy disk drives such as 310, CD ROM drives 306, or external or internal hard drives 308. As indicated previously, these various disk drives and disk controllers are optional devices.

Program instructions may be stored in the ROM 318 and/or the RAM 320. Optionally, program instructions may be stored on a computer readable medium such as a floppy disk or a digital disk or other recording medium, a communications signal or a carrier wave.

A display interface 322 may permit information from the bus 328 to be displayed on the display 324 in audio, graphic or alphanumeric format. Communication with external devices may occur using various communication ports 326. An exemplary communication port 326 may be attached to a communications network, such as the Internet or an intranet. A plurality of user computers may be attached to the communication port 326 via the communications network.

In addition to the standard computer-type components, the hardware may also include an interface 312 that allows for receipt of data from input devices such as a keyboard 314 or other input device 316 such as a remote control, pointer and/or joystick.

An embedded system may optionally be used to perform one, some or all of the operations of the above-described system. Likewise, a multiprocessor system may optionally be used to perform one, some or all of the operations of the above-described system.

It is to be understood that the invention is not limited in its application to the details of construction and to the arrangements of the components set forth in this description or illustrated in the drawings. The disclosed method and system are capable of other embodiments and of being practiced and carried out in various ways. Hence, it is to be understood that the phraseology and terminology employed herein are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the disclosed embodiments.

What is claimed is:

1. A method of organizing and displaying an ordered message thread list, the method comprising:
determining a current counter value;
determining one or more message threads that are accessible by a user;
for each message thread:
determining a first unread message counter value, wherein if the user has not accessed the message thread, the first unread message counter value equals a counter value when the message thread is created, wherein if the user has accessed the message thread, the first unread message counter value equals a counter value when a message is first added to the message thread after the user last accessed the message thread, and
computing an elapsed counter value, wherein the elapsed counter value equals the first unread message counter value subtracted from the current counter value;
ordering the one or more message threads into a message thread list based on the elapsed counter value for each message thread; and
displaying the message thread list.

2. The method of claim 1 wherein determining one or more message threads that are accessible by a user comprises determining, for each message thread, whether the user has permission to access the message thread.

3. The method of claim 1 wherein the message thread list comprises a message thread list ordered from a message thread having a smallest elapsed counter value to a message thread having a largest elapsed counter value.

4. The method of claim 3 wherein the message thread having the smallest elapsed counter value is displayed at the top of the message thread list.

5. The method of claim 1 wherein a message thread comprises one or more of:
an email message; and
a message board message.

6. The method of claim 1 wherein each of the current counter value, the first unread message counter value and the elapsed counter value comprises a time value.

7. A system for organizing and displaying an ordered message thread list, the system comprising:
a processor;
a computer-readable storage medium operably connected to the processor;
a communications network operably connected to the processor; and
at least one computer system operably connected to the communications network,
wherein the computer-readable storage medium contains one or more programming instructions for performing a method of organizing and displaying an ordered message thread list, the method comprising:
receiving, via the communications network, a request for a user's message threads from a computer system;
determining, by the processor, a current counter value;
determining, by the processor, one or more message threads that are accessible by a user;
for each message thread:
determining, by the processor, a first unread message counter value, wherein if the user has not accessed the message thread, the first unread message counter value equals a counter value when the message thread is created, wherein if the user has accessed the message thread, the first unread message counter value equals a counter value when a message is first added to the message thread after the user last accessed the message thread, and
computing, by the processor, an elapsed counter value, wherein the elapsed counter value is equal to the first unread message counter value subtracted from the current counter value;
ordering the one or more message threads into a message thread list based on the elapsed counter value for each message thread; and
transmitting, via the communications network, the message thread list to the computer system.

8. The system of claim 7 wherein determining one or more message threads that are accessible by a user comprises determining, for each message thread, whether the user has permission to access the message thread.

9. The system of claim 7 wherein the message thread list comprises a message thread list ordered from a message thread having a smallest elapsed counter value to a message thread having a largest elapsed counter value.

10. The system of claim 9 wherein the message thread having the smallest elapsed counter value is displayed at the top of the message thread list.

11. The system of claim 7 wherein a message thread comprises one or more of:
an email message; and
a message board message.

12. The system of claim 7 wherein each of the current counter value, the first unread message counter value and the elapsed counter value comprises a time value.

13. A method of organizing and displaying an ordered message thread list, the method comprising:
determining a current counter value;
determining one or more message threads that are accessible by a user;
for each message thread:
determining a first unread message counter value, wherein if the user has not accessed the message thread, the first unread message counter value equals a counter value when the message thread is created, wherein if the user has accessed the message thread, the first unread message counter value equals a counter value when a message is first added to the message thread after the user last accessed the message thread,
computing an elapsed counter value, wherein the elapsed counter value is equal to the first unread message counter value subtracted from the current counter value, and
placing the message thread into an ordered message thread list at a position based on the elapsed counter value for the message thread; and
displaying the ordered message thread list.

14. The method of claim 13 wherein determining one or more message threads that are accessible by a user comprises determining, for each message thread, whether the user has permission to access the message thread.

15. The method of claim 13 wherein the ordered message thread list comprises a message thread list ordered from a message thread having a smallest elapsed counter value to a message thread having a largest elapsed counter value.

16. The method of claim 15 wherein the message thread having the smallest elapsed counter value is displayed at the top of the ordered message thread list.

17. The method of claim 13 wherein a message thread comprises one or more of:
an email message; and
a message board message.

18. The method of claim 13 wherein each of the current counter value, the first unread message counter value and the elapsed counter value comprises a time value.

19. A method of presenting a message thread list to a user, the method comprising:
displaying a plurality of message threads in an order corresponding to the time that is the lesser of (1) the time that has elapsed since a message was first added to a message thread after a user last accessed any message in the message thread, and (2) the time that has elapsed since the message thread was created.
